(19) United States
(12) Patent Application Publication
(10) Pub. No.: US 2010/0283666 A1
(43) Pub. Date: Nov. 11, 2010

(54) RADAR SIGNALS CLUSTERING METHOD USING FREQUENCY MODULATION CHARACTERISTICS AND COMBINATION CHARACTERISTICS OF SIGNALS, AND SYSTEM FOR RECEIVING AND PROCESSING RADAR SIGNALS USING THE SAME

(75) Inventors: Dong-Weon Lee, Daejeon (KR); Jin-Woo Han, Daejeon (KR); Kyu-Ha Song, Daejeon (KR); Young-Jin Ryoo, Daejeon (KR)

Correspondence Address: Vierra Magen Marcus & DeNiro LLP, 575 Market Street, Suite 2500, San Francisco, CA, 94105, US

(73) Assignee: AGENCY FOR DEFENSE DEVELOPMENT, Daejeon (KR)

(21) Appl. No.: 12/690,634

(22) Filed: Jan. 20, 2010

(30) Foreign Application Priority Data
May 8, 2009 (KR) 10-2009-0040095

(51) Int. Cl. G01S 13/00

(52) U.S. Cl. 342/175

(57) ABSTRACT

Disclosed is a radar signal clustering method using frequency modulation characteristics and combination characteristics of signals including: a first step of assigning pulses of received radar signals to cells consisting of parameters including radio frequency (RF) and angle of arrival (AOA) of the pulses; a second step of calculating a pulse density distribution of each cell using a kernel density estimator; a third step of extracting a corresponding cell as a frequency fixed cluster if the calculated pulse density distribution is greater than a threshold of the frequency fixed cluster; a fourth step of making cell groups by merging remaining cells that are not extracted as the frequency fixed clusters; a fifth step of calculating a pulse density distribution of each cell group by using the kernel density estimator for each cell group; and a sixth step of comparing the calculated pulse density distribution for each cell group with each threshold according to a signal combination type of frequency agile clusters, thus to classify and extract each cell group according to the signal combination type.

### CROSS-REFERENCE TO A RELATED APPLICATION

Pursuant to 35 U.S.C. §119(a), this application claims the benefit of earlier filing date and right of priority to Korean Application No. 10-2009-0040095, filed on May 8, 2009, the contents of which is incorporated by reference herein in its entirety.

### BACKGROUND OF THE INVENTION

1. Field of Invention

The present invention relates to radar pulses, and particularly, to a clustering method of radar pulses.

2. Background of the Invention

In general, Electronic warfare Support (ES) system involves receiving enemy signals to identify and locate threat emitters to help determine the enemy's force structure and deployment. Its primary functions are detection of threat signals, identification of threat types and operating modes, location of threat emitters, display of threat information to support situation awareness.

An ES system measures pulse characteristics of received signals and discriminates the pulse trains that have a rule, correlation, continuance from collected data. The ES system then analyzes the characteristics of the data and identifies the emitters through comparison with emitter identification data (EID).

In dense and complex signal environments, the capability of high-speed and accurate signal analysis is required to identify individual radar signals at real-time. For this, the clustering method of radar pulses as a preprocessing technique in ES system has been developed to alleviate the load of signal analysis and support reliable analysis.

Clustering in the ES system is a special application of data clustering to classify unknown radar emitters from received radar pulse samples. Compared with an ordinary data clustering, the radar emitter classification has some unique challenges. First of all, the radar pulse samples are of high dimension. Second, the number of received pulses are very variable depending on signal environments. Thus, the number of pulses received under good environments may be as high as several millions per second. However, in hostile environments, the number of received pulses may be small, e.g., a coupled of tens for each radar signal. Third, the radar signals may be of various types of modulation, and the pulse characteristics may depend on the type of modulation. Therefore, it is necessary to consider these factors for the clustering method in the ES system.

Clustering of radar pulses is performed as preprocessing for signal analysis between radar signal measurement process and signal analysis process. Clustering process should provide reliable cluster information to signal analysis process. For this, clustering method is required to carry out following tasks: 1) to avoid scattering pulses from a radar into different clusters, 2) to avoid forming excessively huge clusters and 3) to minimize the processing time.

Signal parameters for each radar pulse collected by a radar signal receiving unit may include PA, PW, RF, AOA, TOA and the like. Of them all, the signal parameters such as pulse amplitude, pulse width, and TOA except for pulse RF and AOA are hard to be used to cluster radar pulses due to distortions caused by transmission environments or the like.

RF is the key parameter for clustering of radar signals since it represents the inherited feature of individual radar systems. But, there are several types of frequency modulation such as fixed, agile, hopping and pattern. Hence, the type of frequency modulation is considered with caution in clustering of radar pulses.

AOA is only determined by the radar's location not by its system design, and hence AOA is the most appropriate parameter for clustering of radar pulses. If there are no reflected signals to cause confusion, a constant AOA will be present over rather long periods of time even when the platform is moving.

Well-known existing radar pulse clustering methods using signal parameters may include a sequential histogram method, a sequential scan method and the like.

In the sequential histogram method, RF and AOA are measured on a pulse to pulse from multiple radars and can be represented by a two dimensional histogram as illustrated in FIG. 5. This method is easy to implement, but the signals with agile frequency modulation can be scattered into two or more clusters in clustering for RF. Also, there are problems of setting a threshold and the size of histogram bin.

On the other hand, the sequential scan method, as illustrated in FIG. 6, sets flags on two dimensional cells corresponding to the AOA and RF and then scans them sequentially in forward and backward orders. This method is the two dimensional approach of AOA and RF, and does not have decision variables such as threshold in the sequential histogram method.

However, there are still some drawbacks. This method cannot discriminate the signals with the fixed frequency modulation or agile frequency modulation. For instance, if the cells of the signals with the fixed frequency modulation are in the cell domain formed by the signals with agile frequency modulation, two cells are merged in a cluster. Also, this method is so time-consuming job because it must scan all cells in twice irrespective of the number of pulses. Therefore; the sequential scan method is not suitable for ES system which requires real-time processing.

As described above, the existing radar pulse clustering methods make clusters depending on RF and AOA upon the clustering process. Those methods cannot identify frequency modulation characteristics and combination characteristics of agile frequency signals in clusters. Further, since they do not consider the frequency modulation characteristics of signals and distribution of pulses dependent on the combination characteristics of the signals in clusters, an accuracy of clustering is lowered, which causes an increase in the load and errors upon the later signal analysis process.

### SUMMARY OF THE INVENTION

Therefore, in order to overcome the drawbacks of the related art, an object of the present invention is to provide an accurate clustering method for radar signals, by identifying frequency modulation characteristics of clusters and combination characteristics of signals by means of distribution characteristics of pulses within clusters.

Another object of the present invention is to provide a radar signal clustering method capable of alleviating the load and errors upon the later signal analysis process, by allowing separate processing of signals with characteristics of fixed frequency modulation or agile frequency modulation through an accurate clustering method based upon the frequency modulation characteristics of clusters and the combination characteristics of signals.

Another object of the present invention is to provide a system for receiving and processing radar signals, capable of acquiring reliable analysis information by reducing processing time of signal analysis and remarkably improving an accuracy of signal analysis by employing a simple and reliable clustering method.

To achieve these and other advantages and in accordance with the purpose of the present invention, as embodied and broadly described herein, there is provided a radar signal clustering method using frequency modulation characteristics and combination characteristics of signals, the method including: a first step of assigning pulses of received radar signals to cells consisting of parameters including RF and AOA of the pulses; a second step of calculating a pulse density distribution of each cell using a kernel density estimator; a third step of extracting a corresponding cell as a frequency fixed cluster if the calculated pulse density distribution is greater than a threshold of the frequency fixed cluster; a fourth step of making cell groups by merging remaining cells that are not extracted as the frequency fixed clusters; a fifth step of calculating a pulse density distribution of each cell group by using the kernel density estimator for each cell group; and a sixth step of comparing the calculated pulse density distribution for each cell group with each threshold according to a signal combination type of frequency agile clusters, thus to classify and extract each cell group according to the signal combination type.

Preferably, the sixth step may include: a seventh step of identifying a cell group as a single type frequency agile cluster if the calculated pulse density distribution for the corresponding cell group is included in a threshold for the single type frequency agile cluster; an eighth step of identifying a cell group as a split type frequency agile cluster if the calculated pulse density distribution for the corresponding cell group is smaller than the threshold for the split type frequency agile cluster; a ninth step of identifying a cell group as an overlap type frequency agile cluster if the calculated pulse density distribution for the corresponding cell group is greater than the threshold for the overlap type frequency agile cluster; and a tenth step of extracting each cluster classified according to the signal combination type.

In one aspect of the present invention, there is provided a system for receiving and processing radar signals including a signal clustering processor operable to: assigning pulses of received radar signals to cells consisting of parameters including RF and AOA of the pulses; calculating a pulse density distribution of each cell using a kernel density estimator; extracting a corresponding cell as a frequency fixed cluster if the calculated pulse density distribution is greater than a threshold of the frequency fixed cluster; making cell groups by merging remaining cells that are not extracted as the frequency fixed clusters; calculating a pulse density distribution of each cell group by using the kernel density estimator for each cell group; identifying a cell group as a single type frequency agile cluster if the calculated pulse density distribution for the corresponding cell group is included in a threshold for the single type frequency agile cluster; identifying a cell group as a split type frequency agile cluster if the calculated pulse density distribution for the corresponding cell group is smaller than the threshold for the split type frequency agile cluster; identifying a cell group as an overlap type frequency agile cluster if the calculated pulse density distribution for the corresponding cell group is greater than the threshold for the overlap type frequency agile cluster; and extracting each cluster classified according to the signal combination type.

The present invention allows an accurate clustering for radar signals by identifying frequency modulation characteristics of clusters and combination characteristics of signals using distribution characteristics of pulses within clusters.

Further, signals with characteristics of fixed frequency modulation or agile frequency modulation can be individually processed by an accurate clustering method based upon the frequency modulation characteristics of clusters and the combination characteristics of signals, thereby enabling an alleviation of the load and errors upon the later signal analysis process.

Also, a system for receiving and processing radar signals, capable of acquiring reliable analysis information, can be provided by reducing processing time of signal analysis and remarkably improving an accuracy of signal analysis by employing a simple and reliable clustering method.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a flowchart illustrating a radar signal clustering method using frequency modulation characteristics and combination characteristics of signals according to the present invention;

FIG. 2 is a view illustrating the distribution of frequency fixed clusters in a frequency domain;

FIG. 3 is a view illustrating the distribution of frequency agile clusters in a frequency domain;

FIG. 4 is a view showing classification results for three types of frequency agile clusters according to the present invention;

FIG. 5 is a view illustrating a sequential histogram method of the existing radar signal clustering methods; and

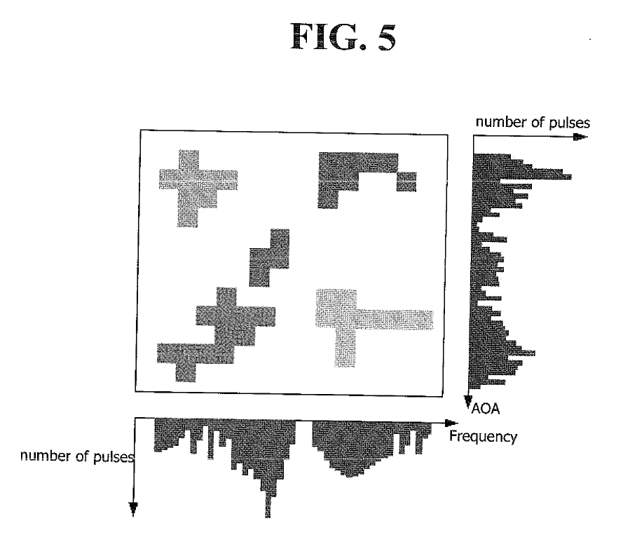

FIG. 6 is a view illustrating a sequential scan method of the existing radar signal clustering methods.

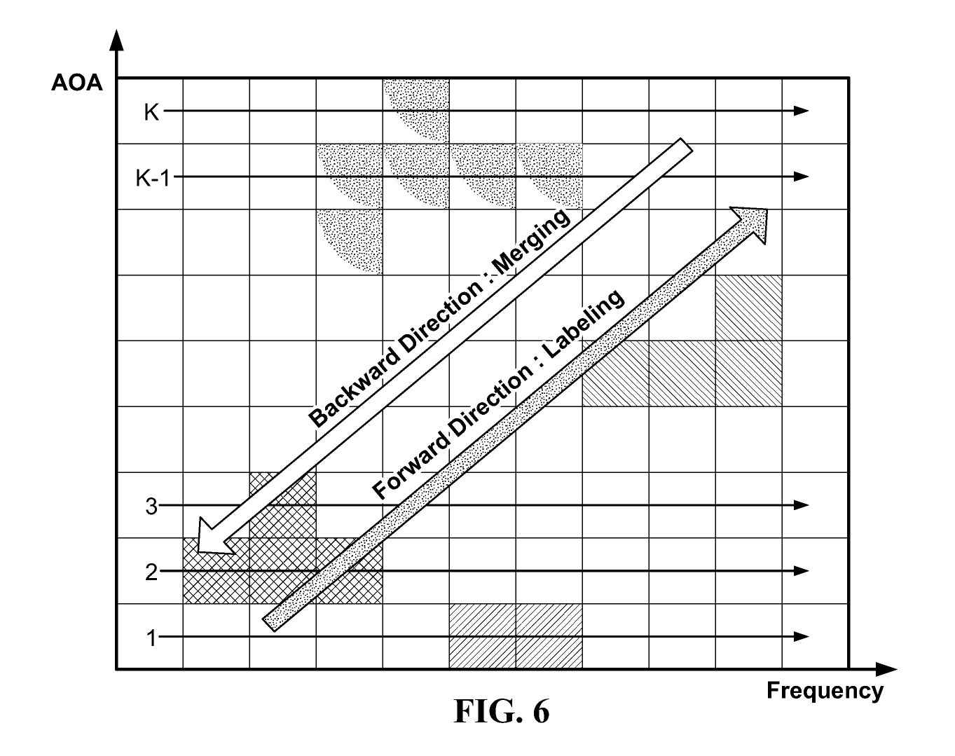

### DETAILED DESCRIPTION OF THE INVENTION

Description will now be given in detail of the present invention, with reference to the accompanying drawings.

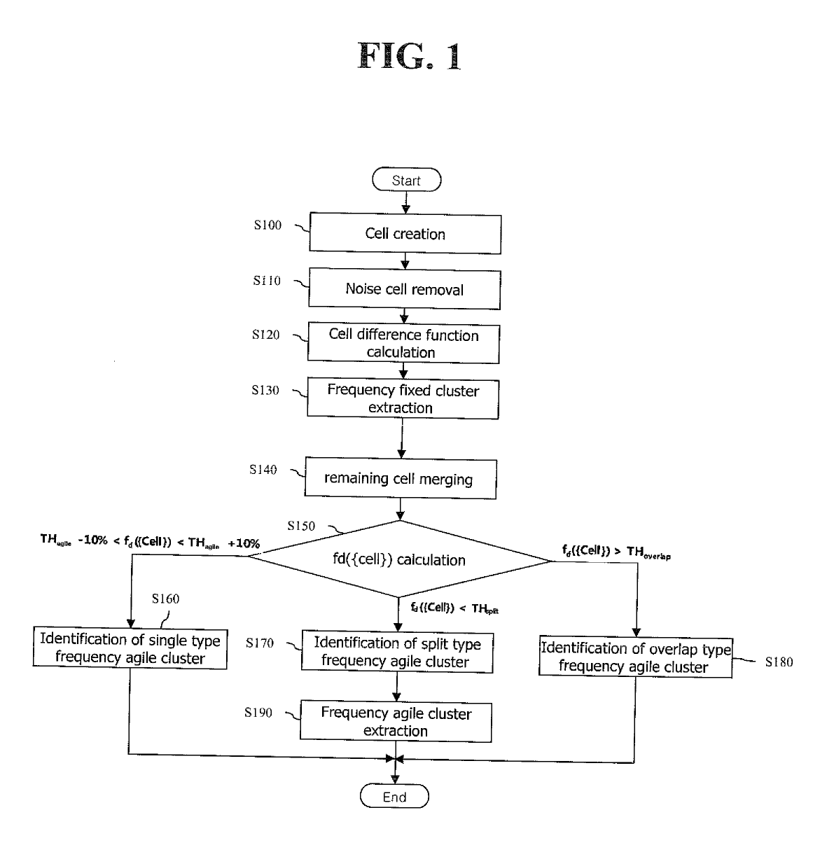

FIG. 1 is a flowchart illustrating a radar signal clustering method using frequency modulation characteristics and combination characteristics of signals according to the present invention.

First, in a cell creation step S100, two dimensional cells consisting of RF and AOA are created, and then pulses of radar signals stored after reception are assigned to the cells.

Here, the size of the cell should be determined with care because it affects to the clustering performance directly. If the cell size is too big, the pulses from several emitters may be assigned to the same cell. And, if the cell size is too small, the pulses from one emitter may be scattered to the several cells.

The present invention defines the size of cell using AOA measurement accuracy σ_{AOA} and RF measurement accuracy σ_{RF} of a radar signal receiving unit. The measurement accuracies are set by root mean square (RMS) unit, which means that the probability of the accuracy being within the range of ±3σ is more than 99%.

Therefore, the present invention sets the cell size as follows.

Cell size=6σ_{AOA}×6σ_{RF}

In a noise cell removal step S110, for all cells with pulses, a cell density, namely, the number of pulses assigned to each cell is compared with a noise threshold THₙₒᵢₛₑ, thereby removing noise cells. The noise cell is determined based upon whether the cell density exceeds the noise threshold THₙₒᵢₛₑ. If a cell is determined to be a noise cell, the corresponding cell is initialized, so as to avoid such cell from affecting the later clustering process.

In a cell difference function calculation step S120, first, in order to identify the distribution of pulses consisting of cells, a kernel density estimator (KDE) f(x) is calculated using a kernel function K(u) for each cell. Also, a difference function f_{d}(x) of cumulative distribution function (CDF) for the KDE f(x) is calculated.

Explaining such calculations in detail, KDE is used to find out the signal distribution. For the KDE, the contribution of each point to the overall density function is expressed by an influence or kernel function. The overall density function is simply the sum of the influence functions associated with each point.

Gaussian function is used as the kernel function as follows.

$$K ( u ) = \frac{1}{\sqrt{2}} exp ( - \frac{1}{2} {u}^{2} )$$

The kernel density estimator f(x) using the kernel function is defined as the following formula where n denotes the number of pulses in a cell, and h denotes a window size.

$$f ( x ) = \frac{1}{nh} {\sum }_{i = 1}^{n} K ( \frac{x - {x}_{i}}{h} )$$

Afterwards, in order to determine the types of clusters, namely, whether a cluster is a frequency fixed cluster or a frequency agile cluster, the difference function f_{d}(x) of CDF is calculated for the KDE. The f_{d}(x) of the CDF is defined as the following formula where x denotes the peak point in the KDE, and σRF denotes the frequency measurement accuracy.

$${f}_{d} ( x ) = {\int }_{t = x - {σ}_{RF}}^{x + {σ}_{RF}} f ( t ) d t$$

Therefore, the difference function f_{d}(x), which denotes a domain value from a peak value to ±σ_{RF} in the KDE graph, represents the density distribution characteristics of pulses consisting of cells.

Next, in a frequency fixed cluster extraction step S130, clusters which have signals with the fixed frequency modulation, namely, the frequency fixed clusters are identified.

Explaining this step in detail, in order to identify the frequency fixed clusters, the kernel density estimator and its difference function f_{d}(x) of the CDF are calculated for all of the cells.

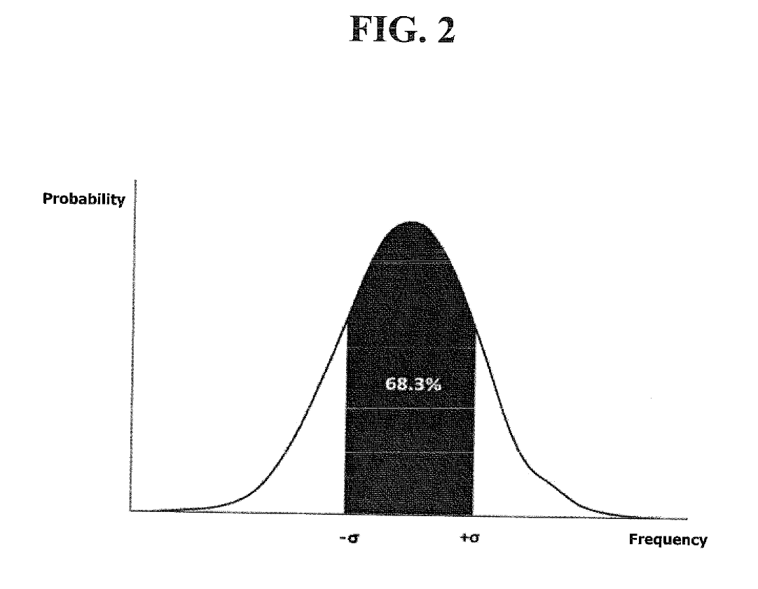

The distribution of the frequency fixed clusters has Gaussian distribution in a frequency domain due to a receiver's measurement error as illustrated in FIG. 2. FIG. 2 illustrates the distribution of frequency fixed clusters in the frequency domain. In FIG. 2, f_{d}(x) is about 0.683, and the present invention considers this value to set a threshold TH_{fixed} for the frequency fixed cluster.

Therefore, if f_{d}(x) of the cluster calculated is higher than TH_{fixed} (i.e., f_{d}(x)>TH_{fixed}) for the frequency fixed cluster, the corresponding cluster is identified as a frequency fixed cluster. On the other hand, if f_{d}(x) of the cluster is lower than TH_{fixed} (i.e., f_{d}(x)<TH_{fixed}) for the frequency fixed cluster, the corresponding cluster is identified as a frequency agile cluster.

Afterwards, in a remaining cell merging step S140, adjacent cells are merged for remaining cells after the extraction of the frequency fixed clusters.

The cell merging is now described in detail. If a current cell has coordinates (x, y), its neighboring (adjacent) cells with coordinates (x−1, y), (x+1, y), (x, y−1) and (x, y+1) are merged so as to make one large cell.

Contrary to the frequency fixed cluster, the pulses from the emitter which has an agile frequency modulation are distributed widely in a frequency domain, so merging the adjacent cells is necessary to identify the frequency agile cluster.

Afterwards, in a cell group difference function calculation step S150, first, a KDE f({cell}) is calculated for each cell group formed by the merging, and then a difference function f_{d}({cell}) of a CDF is calculated for the KDE. Here, the definitions of f({cell}) and f_{d}({cell}) used are the same to those used in the cell difference function calculation step S120.

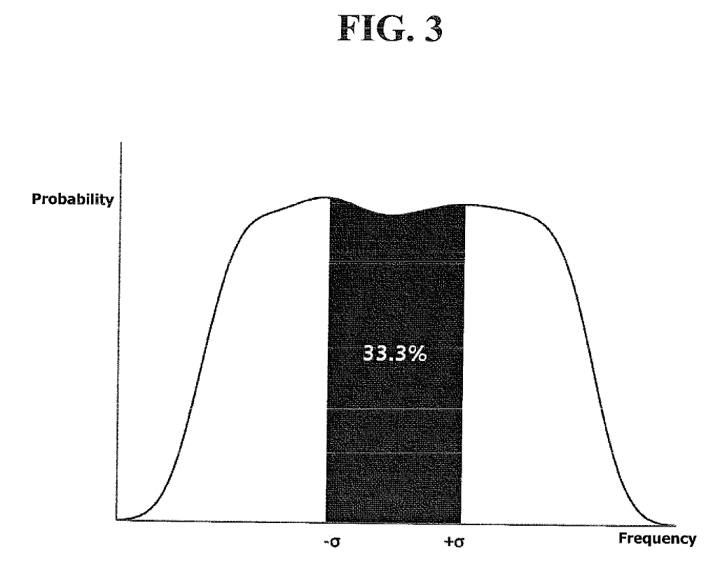

As aforementioned, in general, the pulses from the emitter which has the agile frequency modulation are uniformly distributed in a wide frequency domain. Thus, for the frequency agile cluster, the difference function f_{d}(x) is about 0.333 due to its distribution and cell characteristics, which is illustrated in FIG. 3. FIG. 3 illustrates the distribution of the frequency agile clusters in a frequency domain. The present invention uses this value, namely, 0.333 to set a frequency agile cluster threshold TH_{agile} for the frequency agile cluster.

Further, the present invention classifies signal combination types of frequency agile clusters into single type C_{single}, overlap type Cₒᵥₑᵣₗₐₚ and a split type Cₛₚₗᵢₜ−C_{single} indicates that a cluster has only one frequency agile signal. If the clusters do not belong to the C_{single}, the clusters may be classified into Cₒᵥₑᵣₗₐₚ or Cₛₚₗᵢₜ according to whether signals are overlapped or not.

Cₒᵥₑᵣₗₐₚ indicates that a cluster has two or more frequency agile signals. Cₒᵥₑᵣₗₐₚ may also indicate that such signals exist in an overlapped state. Cₛₚₗᵢₜ indicates that a cluster has two or more frequency agile signals without being overlapped with each other.

Next, in an identification step S160 of a single type frequency agile cluster, the difference function value f_{d}({cell}) calculated in the cell group difference function calculation step S150 is compared with a threshold TH_{single} of a single type frequency agile cluster C_{single}, thus to identify whether a frequency agile cluster is the single type frequency agile cluster C_{single}. Here, the threshold TH_{single} of the single type frequency agile cluster C_{single} may be obtained as follows, TH_{single}=|TH_{agile}+10%|.

If the difference function value f_{d}({cell}) is smaller than or equal to TH_{single} (i.e., TH_{agile}−10%≦f_{d}({Cell})≦TH_{agile}+10%), it is identified as the single type frequency agile cluster C_{single}.

In an identification step S170 of a split type frequency agile cluster, the difference function value f_{d}({cell}) calculated in the cell group difference function calculation step S150 is compared with a threshold THₛₚₗᵢₜ of a split type frequency agile cluster Cₛₚₗᵢₜ, thus to identify whether a frequency agile cluster is the split type frequency agile cluster Cₛₚₗᵢₜ. Here, THₛₚₗᵢₜ=TH_{agile}−10%.

If the difference function value f_{d}({cell}) is smaller than THₛₚₗᵢₜ (i.e., f_{d}({cell})<TH_{agile}−10%), it is identified as the split type frequency agile cluster Cₒᵥₑᵣₗₐₚ.

Afterwards, in an identification step S180 of an overlap type frequency agile cluster, the difference function value f_{d}({cell}) calculated in the cell group difference function calculation step S150 is compared with a threshold THₒᵥₑᵣₗₐₚ of a split type frequency agile cluster Cₒᵥₑᵣₗₐₚ, thus to identify whether a frequency agile cluster is the overlap type frequency agile cluster Cₒᵥₑᵣₗₐₚ. Here, THₒᵥₑᵣₗₐₚ=TH_{agile}+10%.

If the difference function value f_{d}({cell}) is greater than THₒᵥₑᵣₗₐₚ (i.e., f_{d}({cell})>TH_{agile}+10%), it is identified as the overlap type frequency agile cluster Cₒᵥₑᵣₗₐₚ.

Such classification for the frequency agile clusters may be represented as follows. That is,

$$cluster type = \{ \begin{matrix}{C}_{single} & if {f}_{d} ( x ) \leq \vert {TH}_{agile} + 10 \% \vert \\ {C}_{split} & if {f}_{d} ( x ) < {TH}_{agile} - 10 \% \\ {C}_{overlap} & if {f}_{d} ( x ) > {TH}_{agile} + 10 \%\end{matrix} \}$$

Finally, in an extraction step S190 of a frequency agile cluster, the frequency agile clusters are classified and extracted according to the combination type of each cluster (i.e., C_{single}, Cₒᵥₑᵣₗₐₚ, and Cₛₚₗᵢₜ) identified through the comparison with the frequency agile cluster threshold.

The extraction will be described in detail. If a combination type of a cluster is C_{single}, it is identified as one frequency agile cluster, which is then extracted. On the other hand, if the combination type of the cluster is not C_{single}, a distribution type of the KDE is identified, and then cells which cause splitting or overlapping are estimated.

Afterwards, the difference function of the CDF is calculated for each expected cell to discriminate cells causing the split type or overlap type, and clusters are classified based upon the cells to be then extracted.

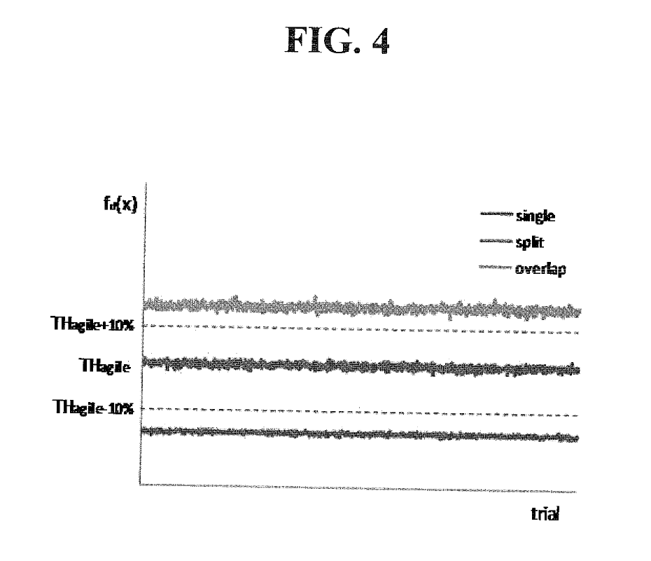

FIG. 4 illustrates the classification results for three types of frequency agile clusters. As illustrated in FIG. 4, it can be noticed that the frequency agile clusters are classified by the corresponding thresholds.

Hereinafter, description will be made of the performance of the clustering method according to the present invention in comparison with the existing clustering methods through a computer simulation in various signal environments.

The input data consisted of 10,240 pulses for various emitters which individually have AOA, RF, pulse repetition interval (PRI) and the like. The performance evaluation is performed with changes in the input signals, and the results are followed at Table 1.

TABLE 1

| | | | Over | Under |
|---|---|---|---|---|
| Clustering | Type | Clustering | Clustering | Clustering |
| Method | Classification | Probability | Probability | Probability |
| Histogram | Δ | 66.7% | 30% | 3.3% |
| Sequential | x | 53.3% | 6.7% | 40% |
| Scan | | | | |
| Present | ∘ | 98.5% | 0% | 1.5% |
| Invention | | | | |

As can be seen in the results of Table 1, the existing sequential histogram and sequential scan methods do not make clusters properly for the input signals. For the sequential histogram method, it has the more clusters than expected as the number of input signal increases, and many pulses which do not exceed the threshold remain unused. The sequential scan method has the fewer clusters than expected, and also it cannot discriminate the modulation type of carrier frequency.

On the other hand, it can be seen that the clustering method according to the present invention is performed properly and can identify the types of frequency agile clusters. Type information is very important in the signal analysis process and it is useful for pulse train extraction.

As described above, the present invention can provide an accurate clustering method based upon characteristics of frequency modulation of clusters and combination characteristics of signals through the series of processes. Also, the present invention enables separate processing of signals with characteristics of fixed frequency modulation or characteristics of agile frequency modulation, which allows shortening of processing time of signal analysis and improving of accuracy of signal analysis, resulting in providing reliable information.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A radar signal clustering method using frequency modulation characteristics and combination characteristics of signals, the method comprising:
assigning pulses of received radar signals to cells consisting of parameters including radio frequency (RF) and angle of arrival (AOA), based on the radio frequency (RF) and the angle of arrival (AOA) of the pulses;
calculating a pulse density distribution of each cell using a kernel density estimator;
extracting a corresponding cell as a frequency fixed cluster if the calculated pulse density distribution is greater than a threshold of the frequency fixed cluster;
making cell groups by merging remaining cells that are not extracted as the frequency fixed clusters;
calculating a pulse density distribution of each cell group by using the kernel density estimator for each cell group; and
comparing the calculated pulse density distribution for each cell group with each threshold according to a signal combination type of frequency agile clusters, thus to classify and extract each cell group according to the signal combination type.

2. The method of claim 1, wherein comparing the calculated pulse density comprises:
identifying a cell group as a single type frequency agile cluster if the calculated pulse density distribution for the corresponding cell group is included in a threshold for the single type frequency agile cluster;
identifying a cell group as a split type frequency agile cluster if the calculated pulse density distribution for the corresponding cell group is smaller than the threshold for the split type frequency agile cluster;
identifying a cell group as an overlap type frequency agile cluster if the calculated pulse density distribution for the corresponding cell group is greater than the threshold for the overlap type frequency agile cluster; and
extracting each cluster classified according to the signal combination type.

3. The method of claim 2, wherein:
the single type frequency agile cluster indicates that the cluster has only one frequency agile signal, the split type frequency agile cluster indicates that the cluster has two or more frequency agile signals without being overlapped with each other, and the overlap type frequency agile cluster indicates that the cluster has two or more frequency agile signals in an overlapped state.

4. The method of claim 1, wherein:
in the assigning pulses, the cell size is set by considering AOA measurement accuracy and RF measurement accuracy of a radar signal receiving unit.

5. The method of claim 1, further comprising:
prior to performing the calculating a pulse density distribution of each cell using a kernel density estimator, if the number of pulses assigned to the cell is smaller than a noise threshold, the cell is identified as a noise cell and then initialized so as to remove the noise cell.

6. The method of claim 1, wherein:
when calculating the pulse density distribution of each cell using a kernel density estimator, the pulse density distribution for the cell is obtained by calculating a difference function of a cumulative distribution function for the kernel density estimator.

7. The method of claim 1, wherein:
the making cell groups includes adjacent cells being merged so as to perform merging of the remaining cells.

8. The method of claim 1, wherein:
when calculating the pulse density distribution of each cell group by using the kernel density estimator for each cell group, the pulse density distribution for the cell group is obtained by calculating a difference function of a cumulative distribution function for the kernel density estimator.

9. A system for receiving and processing radar signals, comprising:
a signal clustering processor operable to:
assign pulses of received radar signals to cells consisting of parameters including RF and AOA of the pulses, calculate a pulse density distribution of each cell using a kernel density estimator, extract a corresponding cell as a frequency fixed cluster if the calculated pulse density distribution is greater than a threshold of the frequency fixed cluster, make cell groups by merging remaining cells that are not extracted as the frequency fixed clusters, calculate a pulse density distribution of each cell group by using the kernel density estimator for each cell group, identify a cell group as a single type frequency agile cluster if the calculated pulse density distribution for the corresponding cell group is included in a threshold for the single type frequency agile cluster, identify a cell group as a split type frequency agile cluster if the calculated pulse density distribution for the corresponding cell group is smaller than the threshold for the split type frequency agile cluster, identify a cell group as an overlap type frequency agile cluster if the calculated pulse density distribution for the corresponding cell group is greater than the threshold for the overlap type frequency agile cluster, and extract each cluster classified according to the signal combination type.

10. A method for receiving and processing radar signals, comprising:
assigning pulses of received radar signals to cells consisting of parameters including RF and AOA of the pulses;
calculating a pulse density distribution of each cell using a kernel density estimator;
extracting a corresponding cell as a frequency fixed cluster if the calculated pulse density distribution is greater than a threshold of the frequency fixed cluster;
making cell groups by merging remaining cells that are not extracted as the frequency fixed clusters;
calculating a pulse density distribution of each cell group by using the kernel density estimator for each cell group;
identifying a cell group as a single type frequency agile cluster if the calculated pulse density distribution for the corresponding cell group is included in a threshold for the single type frequency agile cluster;
identifying a cell group as a split type frequency agile cluster if the calculated pulse density distribution for the corresponding cell group is smaller than the threshold for the split type frequency agile cluster;
identifying a cell group as an overlap type frequency agile cluster if the calculated pulse density distribution for the corresponding cell group is greater than the threshold for the overlap type frequency agile cluster; and
extracting each cluster classified according to the signal combination type.
